(19) United States
(12) Patent Application Publication
(10) Pub. No.: US 2025/0081987 A1
(43) Pub. Date: Mar. 13, 2025

(54) SUNFLOWER SEED PROTEIN CONCENTRATE AND PROCESS FOR PRODUCTION

(71) Applicant: Louis Dreyfus Company Plant Proteins LLC, Livermore, CA (US)

(72) Inventors: Prasanth Kumar Sasidharan Pillai, Livermore, CA (US); Manoj Kumar, Livermore, CA (US)

(73) Assignee: Louis Dreyfus Company Plant Proteins LLC, Livermore, CA (US)

(21) Appl. No.: 18/792,413

(22) Filed: Aug. 1, 2024

Related U.S. Application Data
(60) Provisional application No. 63/532,330, filed on Aug. 11, 2023.

(51) Int. Cl. A23J 1/14

(52) U.S. Cl. CPC A23J 1/144

(57) ABSTRACT

Provided herein are Sunflower Seed Protein Concentrates with novel characteristics, processes for producing Sunflower Seed Protein Concentrates and methods of using the Sunflower Seed Protein Concentrates disclosed.

### CROSS-REFERENCE

This application claims benefit of U.S. Provisional Patent Application No. 63/532,330 filed Aug. 11, 2023, which application is incorporated herein by reference in its entirety.

### BACKGROUND OF THE INVENTION

Oil seeds, such as sunflower seeds, are an emerging source of proteins for culinary applications. Recent trends toward the use of vegetable proteins to replace animal-derived protein has created a significant demand for the production of plant protein products with unique and desirable qualities, particularly for use in foods meant to replace animal-based products. Oil seed-derived proteins have become a coveted source for producing nutritionally-enhanced products and meat and dairy substitutes with preferred textural appeal and varied functionalities. Therefore, protein concentrates from seeds that are both economical and have desirable physical properties for use in plant-based foods and products is needed.

The production of protein concentrate from sunflower seed has been actively pursued. For example, U.S. Pat. No. 8,728,542 describes production of sunflower seed protein preparations involving pressing, supercritical CO2 and/or superheated hexane. Various Other disclosures employ heat to provide sunflower protein concentrates, such as U.S. Pat. No. 10,645,950. Other procedures involving selective membrane techniques and/or diafiltration are described in U.S. published application No. 2022-0053791A1. Production of novel sunflower protein compositions with unique functionality by procedures that are technologically and economically viable are in constant demand.

### SUMMARY OF THE INVENTION

The present invention provides a process for producing a sunflower protein concentrate (SFPC) from de-oiled sunflower seed flour that is economical and produces sunflower protein concentrate that has unique composition and functionality. The process involves use of low temperatures, below where denaturation of proteins occurs, to produce a sunflower protein concentrate with a protein content of about 55-70 wt % (N×6.25) on a dry basis while maintaining the native form of the proteins in the concentrate. The process also does not require membrane filter-based separation. The sunflower protein concentrate has highly desirable foaming, gelation and emulsion attributes, making it applicable to many plant-based food and beverage uses.

In one aspect of the invention, a process is provided for extracting a sunflower protein concentrate comprising, stepwise, extracting in 30-70% ethanol in water (by volume) dehulled, milled, de-oiled, desolvated sunflower seed flour having ≤3% oil, the extraction performed at a maintained temperature of 30-62° C. and a pH range of 4-7, then removing the ethanol from the sunflower protein concentrate and water and drying the sunflower seed protein concentrate to a moisture range of 4-10%. In certain embodiments, one or more of the alcohol extraction, solvent removal and washing of the canola protein concentrate are performed using a Nutsche filter. In certain embodiments, the de-oiled sun flour seed flour contains ≤2% oil. In some embodiments, the sunflower seed flour contains ≤1% oil. In certain embodiments, the de-oiled, desolvented sunflower seed flour contains ≤500 ppm hexane. In some embodiments, the de-oiled, desolvented sunflower seed flour contains ≤100 ppm hexane. In some embodiments, the protein content of the de-oiled, desolvated sunflower seed flour is 45-55% protein (N×6.25), on a dry basis. In certain embodiments, the extraction step is carried out at 50-60° C. In some embodiments, the extraction step is carried out at pH 4-5. In certain embodiments, the extraction step is carried out for 15-60 minutes. In some embodiments, all steps other than sterilizing and/or pasteurizing are performed at about ≤60° C.

In another aspect of the invention, a sunflower protein concentrate is provided. In certain embodiments, the sunflower protein concentrate produced by the above process is provided. In certain embodiments, the sunflower protein concentrate has a protein content of 55-75% by weight (N×6.25) on a dry basis. In certain embodiments, the sunflower protein concentrate has a protein content of 55-70% by weight (N×6.25) on a dry basis. In certain embodiments, the sunflower protein concentrate protein component comprises 50-90% 11S helianthin proteins and 10-40% 2S albumin proteins. In some embodiments, the sunflower protein concentrate protein component comprises 55-75% 11S helianthin proteins and 15-30% 2S albumin proteins and/or a mixture of 2S albumin and oleosin proteins. In certain embodiments, the sunflower protein concentrate comprises ≤3% oil, 30-40% carbohydrates, 4-6% ash and 0.1-2% chlorogenic acid. In some embodiments, the protein in the sunflower protein concentrate is substantially maintained in its native form. In certain embodiments, the sunflower protein concentrate has a foaming expansion capacity of ≥180% at a concentration of ≥4% by weight in water. In some embodiments, the sunflower protein concentrate has a foaming expansion capacity of 180-300% at a concentration of ≥4% by weight in water. In certain embodiments, the sunflower protein concentrate has a foaming stability of ≥60% at a concentration of ≥4% by weight in water after 1 hour. In some embodiments, the sunflower protein concentrate has a foaming stability of 60-90% at a concentration of ≥4% by weight in water after 1 hour. In certain embodiments, the sunflower protein concentrate has emulsion stability of 100% at a protein concentration ≥1% in equal parts oil and water by volume after ≥24 hours. In some embodiments, the sunflower protein concentrate has emulsion stability of 100% at a protein concentration of 11-5% in equal parts oil and water by volume after ≥24 hours. In some embodiments, the emulsion is prepared at a pH of 5-7. In certain embodiments, the sunflower protein concentrate has a least gelation concentration of about 5% in water. In certain embodiments, the sunflower protein concentrate has a solubility of 18-30% at pH7 at a concentration of >4% by weight in water. In some embodiments, the sunflower protein concentrate displayed a water holding capacity of 4-10 g/g and a oil holding capacity of 3-9 g/g.

In a different aspect of the invention, a foam comprising the sunflower protein concentrates described above is provided.

In another aspect of the invention, a gel comprising the sunflower protein concentrates described above is provided.

In yet another embodiment, an emulsion comprising the sunflower protein concentrates described above is provided.

In a different aspect of the invention, use of the sunflower protein concentrates described above in the production of a foam is provided. In another aspect of the invention, use of the sunflower protein concentrates described above in the production of a gel is provided. In yet another aspect of the invention, use of the sunflower protein concentrates described above in the production of an emulsion is provided. In some embodiments, the emulsion is an oil/water emulsion.

In a different aspect of the invention, use of the sunflower protein concentrates described above in a food or beverage application is provided. In some embodiments, the food or beverage application is selected from milk shake, protein bars, meat analogues, confectionary, nutritional supplements and dairy alternatives. In certain embodiments, the dairy alternative is selected from creamers, ice cream, yogurt and cheese.

In yet a different aspect, a food or beverage comprising the sunflower protein concentrates described above is provided.

### BRIEF DESCRIPTION OF THE DRAWINGS

FIGS. 1A-C shows sunflower seeds, dehulled, milled ground sunflower seed flour and de-oil, desolvented sunflower seed flour, respectively.

FIG. 2 shows hexane with extracted oil after each of 4 rounds of extraction of sunflower seed oil from ground sunflower seed flour.

FIG. 3 shows SFPC produced using the sunflower protein extraction process described herein.

FIG. 4 shows differential scanning calorimetry performed on the SFPC produced using the sunflower protein concentrate extraction process disclosed herein.

FIG. 5 shows an SDS-PAGE analysis of SFPC, showing the presence of 11S helianthin proteins, and 2S albumin proteins.

FIG. 6 shows samples of gels produced using the SFPC of the invention, as described in Example 5.

FIGS. 7A-7B show samples of emulsions and the mayonnaise-like quality of such emulsions, respectively, as described in Example 6.

FIGS. 8A-8B show foam expansion after foaming and foam stability 1 hour after foaming, respectively, as described in Example 7.

### DETAILED DESCRIPTION OF THE INVENTION

Processes are provided for the production of a protein concentrate from de-oil, desolvented sunflower seed flour (SFPC), as well as sunflower concentrate compositions, compositions comprising sunflower protein concentrates and uses for such sunflower protein concentrates. The processes involve the extraction of de-oiled, desolvented sunflower seed flour with 30-70% ethanol in water at low temperatures. The SFPC is amenable to further uses in the form of foams, gels and emulsions and in various food and beverage applications.

Before the present processes, compositions and uses are described, it is to be understood that this invention is not limited to the particular methods or compositions described, which may, of course, vary. It is also to be understood that the terminology used herein is for the purpose of describing particular embodiments only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limits of that range is also specifically disclosed. Each smaller range between any stated value or intervening value in a stated range and any other stated or intervening value in that stated range is encompassed within the invention. The upper and lower limits of these smaller ranges may independently be included or excluded in the range, and each range where either, neither or both limits are included in the smaller ranges is also encompassed within the invention, subject to any specifically excluded limit in the stated range. Where the stated range includes one or both of the limits, ranges excluding either or both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, some potential and preferred methods and materials are now described. All publications mentioned herein are incorporated herein by reference to disclose and describe the methods and/or materials in connection with which the publications are cited. It is understood that the present disclosure supersedes any disclosure of an incorporated publication to the extent there is a contradiction.

As will be apparent to those of skill in the art upon reading this disclosure, each of the individual embodiments described and illustrated herein has discrete components and features which may be readily separated from or combined with the features of any of the other several embodiments without departing from the scope or spirit of the present invention. Any recited method can be carried out in the order of events recited or in any other order which is logically possible.

It must be noted that as used herein and in the appended claims, the singular forms “a”, “an”, and “the” include plural referents unless the context clearly dictates otherwise.

The publications discussed herein are provided solely for their disclosure prior to the filing date of the present application. Nothing herein is to be construed as an admission that the present invention is not entitled to antedate such publication by virtue of prior invention. Further, the dates of publication provided may be different from the actual publication dates which may need to be independently confirmed.

### Definitions

The term “about”, particularly in reference to a given quantity, is meant to encompass deviations of plus or minus five percent.

“Extracting” or “extraction” means the removal or separation of one or more component(s) of a multicomponent composition.

“De-oiled sunflower seed flour” means sunflower seed flour from which 97-≥99% of the oil has been removed through an oil extraction process. In some instances, the oil content of the de-oiled sunflower seed flour is ≤1%. Such a process is described in a concurrently filed patent application and exemplified in Example 1.

“Desolventing” means the removal of residual solvent, such as hexane, from de-oiled seed flour. “Desolvented” means something that has gone through desolventing.

“Protein component of the sunflower protein concentrate” means that portion of the SFPC that is protein. Therefore, a percentage of the protein component of the SFPC is a percentage only of the protein in the SFPC, rather than a percentage of the total SFPC composition.

“Sunflower seed flour” means dehulled, milled sunflower seeds.

“Substantially in native form” in the context of proteins in in oil seed flour means that the proteins have not been denatured due to, for example, exposure to excessive heat, such that the 3-dimensional structure of the proteins are generally maintained in the form found in the pre-processed seed.

Extracting Sunflower Protein Concentrate from Sunflower Seed Flour

Processes are provided for the production of sunflower protein concentrates from de-oil, desolvented sunflower seed flour. A process for de-oiling and desolventing is disclosed in concurrently filed U.S. patent application Ser. No. ______ incorporated herein by this reference. A brief description of the de-oiling and desolventing process is described in Example 1. Other means of providing de-oiled, desolvented sunflower seed flour are known in the art.

In certain embodiments of the present processes, de-oiled, desolvented sunflower seed flour is used, having been prepared from ground sunflower seeds that had previously been shelled. The de-oiled, desolvented sunflower seed flour will generally contain ≤2% oil, having been extracted by known methods. In some embodiments, the de-oiled, desolvented sunflower seed flour contains ≤1% oil. The de-oiled, desolvented sunflower seed flour typically contains ≤500 parts per million (ppm) hexane. In some embodiments the de-oiled, desolvented sunflower seed flour contains ≤100 ppm hexane. In some embodiments, the oil is extracted from the ground sunflower seed flour with hexane using a Nutsche filter. The de-oiled sunflower seed flour is then desolventred, producing a sunflower seed flour having ≤2% oil and ≤500 ppm hexane.

In some embodiments, the temperature of the de-oiling and desolventing process is maintained below 60° C. throughout the production of the sunflower seed flour. The de-oiled, desolvented sunflower seed flour typically has a protein content of 45-55% (N×6.25), on a dry basis.

The de-oiled, desolvented sunflower seed flour is subjected to extraction by placing the sunflower seed flour in a solution of 30-70% (volume to volume) alcohol at a range of pH 4 to pH 7 and at a temperature of about 30-62° C. While ethanol is typically used, other alcohols, such as isopropanol, 1-propanol and 2-propanol, may also be used. In some embodiments the pH range of the ethanol solution is narrower, such as pH 4 to pH 5. In some embodiments, the temperature range is narrower, in the range of about 50-60° C. It is important to keep the temperature below that which causes denaturation of proteins in the sunflower seed flour and sunflower protein concentrate. Therefore, use of temperatures exceeding about 60° C. for any significant amount of time is contrary to the current invention. Generally, temperature is kept at or below about 60° C. throughout the sunflower protein concentrate process. Typically the alcohol extraction is performed for 15-60 minutes. This alcohol extraction process can be carried out subsequently to de-oiling in the same Nutsche filter.

The alcohol is then removed from the extracted sunflower seed flour, now sunflower protein concentrate, and water. Means for removing alcohol, such as ethanol, from a wet powder are well known in the art. Any of a number of commercially available desolventizers may be used. Any method or combination of methods of removing the alcohol may be employed, and the determination of a proper method of separating a liquid fraction from the solids is well within the skill of the ordinary artisan. In certain embodiments, the temperature of the sunflower protein concentrate is kept below about 60° C. during alcohol removal.

Optionally, after the ethanol extraction, the ethanol extracted protein is separated by decanting and/or centrifuging and may get subsequent washes with water at precipitation pH (e.g, pH 4-5). The separated protein is then diluted with water adjusted to about pH 7 and homogenized, creating a protein slurry. The protein slurry is homogenized by means known in the art. For example, a high pressure homogenizer may be used.

The sunflower protein concentrate and water, either immediately post removal of the alcohol or as the slurry, is then optionally sterilized and/or pasteurized. This is the only time at which the extracted protein is subjected to temperatures above about 60° C. Means for sterilizing protein for use in foods are known in the art. An example of such a means is direct steam injection. The protein slurry may be subjected to direct steam injection for between 2 seconds and 10 minutes.

The sunflower concentrate is dried by standard means generally known to the skilled artisan, typically to a moisture level of 4-10%. In certain embodiments, the temperature of the sunflower protein concentrate is kept below about 60° C. during drying. The sunflower protein concentrate may then be used in various applications, as further described below.

### Sunflower Protein Concentrates

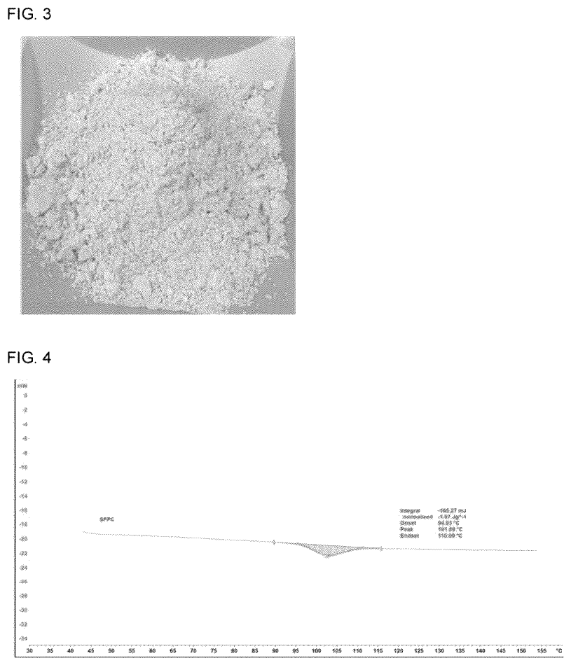

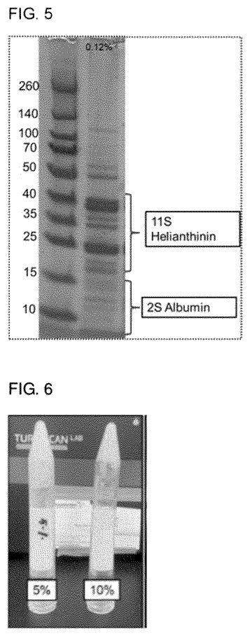

In addition to the production of sunflower protein concentrate (SFPC), the present invention provides sunflower protein concentrates, including SFPCs produced by such processes, having particular useful characteristics. FIG. 3 shows an example of The SFPC produced by the above process having protein content of 50-75% by weight on a dry basis, calculated using the Kjeldahl method (N×6.25). In some embodiments, the protein content is 55-70%. The process allows for the protein in the SFPC to maintain its native form (FIG. 4). The protein of the present SFPC contains 11S helianthin protein and 2S albumin proteins. The protein component of the SFPC typically comprises 50-90% 11S helianthin proteins and 10-40% 2S albumin proteins. In some embodiments, the 11S helianthin proteins and 2S albumin proteins make up 55-75% and 15-30%, respectively, of the protein component of the SFPC. (FIG. 5) In addition, the SFPC typically contains 1-2% oil, 30-40% carbohydrates, 4-6% ash and 0.1-2% chlorogenic acid. The protein in the SFPC of the present invention is in its substantially native form. FIG. 4 shows a differential scanning thermogram of SFPC produced using the present process. The thermogram shows an exothermic event at about 101° C., corresponding to the denaturation of protein within the SFPC.

The SFPC of the present invention has several attributes that make it especially useful in the plant-based food industry. For example, the SFPC is capable of gelling in water at a concentration of about 5% (least gelling concentration). FIG. 6 shows examples of gelled SFPC in water at a concentration of 5% and 10%, where the gelling was produced by heating to 95° C. followed by cooling to 5° C.

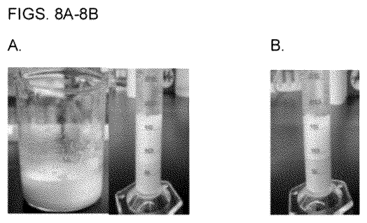

Additionally, the SFPC has foaming expansion capacity of ≥180% at a concentration of ≥5%, weight to weight, in water. In some embodiments, the SFPC has foaming expansion capacity of 180-300% at a concentration of ≥4%, weight to weight, in water. In addition, the SFPC at a concentration of ≥4% in water has foaming stability of 60-90% after 1 hour. FIGS. 8A and B show an example of 200-250% foaming expansion of 5% SFPC in water and foaming stability of 80-90% after 1 hour, respectively. Foaming expansion capacity (% FE) was calculated using the equation % FE=Vfo/Vli×100, where Vfo is foam volume and Vli is the volume of the liquid before foaming.

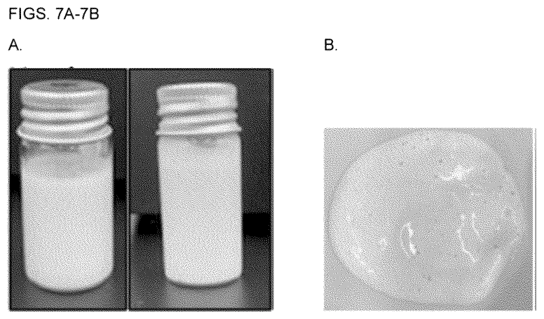

The SFPC also has the capacity to form an emulsion in a 1:1 mixture of water and oil (volume to volume) at a SFPC concentration of ≥1% (weight to weight). At SFPC concentrations of ≥1%, weight to weight, in a water and oil 1:1 mixture, volume to volume, emulsions maintained 100% stability after 24 hours. In some embodiments, emulsion of 1-5% SFPC, weight to weight, in a water and oil 1:1 mixture, volume to volume, maintain 100% stability after 24 hours. FIG. 7A shows emulsion of 1-4% (w/w) SFPC in equal parts water and oil. FIG. 7B demonstrates the mayonnaise-like texture of the SFPC-based emulsion. In addition, the sunflower protein concentrate has a solubility of 18-30% at pH7 at a concentration of ≥4% by weight in water. In some embodiments, the sunflower protein concentrate displayed a water holding capacity of 4-10 g/g and a oil holding capacity of 3-9 g/g.

The gelling, foaming and emulsification attribute of the SFPC of the present invention provide for various plant-based food applications, as further described below.

### Uses of Sunflower Protein Concentrates

The sunflower protein concentrates have a variety of uses, particularly in plant-based food and beverage applications. The SFPC of the present invention finds use in, for example, milk shakes, protein bars, meat analogues, confectionary, condiments, mayonnaise, salad dressing, nutritional supplements and dairy alternatives such as creamer, ice cream, yogurt, buttermilk and cheese. These are no-limiting examples of food and beverages comprising SFPC of the present invention.

### Exemplary Non-Limiting Aspects of the Disclosure

Aspects, including embodiments, of the present subject matter described above may be beneficial alone or in combination, with one or more other aspects or embodiments. Without limiting the foregoing description, certain non-limiting aspects of the disclosure numbered 1-33 are provided below. As will be apparent to those of skill in the art upon reading this disclosure, each of the individually numbered aspects may be used or combined with any of the preceding or following individually numbered aspects. This is intended to provide support for all such combinations of aspects and is not limited to combinations of aspects explicitly provided below:
1. A sunflower seed protein concentrate process comprising:
   a. extracting in 30-70% ethanol in water (by volume) from de-oiled, desolvated sunflower seed flour having ≤3% oil, the extraction comprising the parameters of:
      i) maintaining a temperature of 30-62° C.,
      ii) at a pH range of pH 4-7.
   b. removing the ethanol from the sunflower protein concentrate and water;
   c. optionally washing the sunflower protein concentrate with water at pH 4-6, then diluting the sunflower protein concentrate with water at pH 7 to create a slurry and homogenizing said slurry,
   d. optionally sterilizing and/or pasteurizing the wet sunflower protein concentrate, and
   e. drying the wet sunflower protein concentrate to a moisture range of 4-10%.
2. The process of Aspect 1, wherein the extraction is performed in a Nutsche filter.
3. The process of and any of Aspects 1-2, wherein the de-oiled, desolvented sunflower seed flour contains ≤2% oil.
4. The process of any of Aspects 1-3, wherein the sunflower seed flour contains ≤500 ppm hexane.
5. The process of any of Aspects 1-4, wherein the de-oiled, desolvented sunflower seed oil contains ≤100 ppm hexane.
The process of Aspect 1, wherein the protein content of the dried de-oiled sunflower seed flour is 45-55% protein (N×6.25), on a dry basis.
6. The process of any of Aspects 1-5, wherein steps a. is carried out at 50-60° C.
7. The process of any of Aspects 1-6, wherein step a. is carried out at pH 4-5.
8. The process of any of Aspects 1-7, wherein step a. is carried out for 15-30 minutes.
9. The process of any of Aspects 1-8, wherein steps b., c. and e. are carried out at about ≤60° C.
10. A sunflower protein concentrate produced by the process of any of Aspects 1-9.
11. The sunflower protein concentrate of Aspect 10 having a protein content of 50-75% protein.
12. The sunflower protein concentrate of any of Aspects 1-11 having a protein content of 55-70% protein.
13 The sunflower protein concentrate of any of Aspects 10-12 comprising in its protein component 50-90% 11S helianthin and 10-40% 2S albumin and oleosin proteins.
14. The sunflower protein concentrate of any of Aspects 10-13 comprising in its protein component 55-75% 11S helianthin and 15-30% 2S albumin and oleosin proteins 15. The sunflower protein concentrate of any of Aspects 10-14 comprising:
   a. 1-3% oil,
   b. 30-40% carbohydrates,
   c. 4-6% ash,
   d. 0.1-2% chlorogenic acid.
16. The sunflower protein concentrate of any of Aspects 10-15, wherein the protein is substantially in its native form.
17. The sunflower protein concentrate of any of Aspects 10-16 having a foaming expansion capacity of ≥180% at ≥4% (w/w) sunflower protein concentrate in water.
18. The sunflower protein concentrate of any of Aspects 1-17 having a foaming expansion capacity of 180-300% at ≥4% (w/w) sunflower protein concentrate.
19. The sunflower protein concentrate of any of Aspects 10-18 having a foaming stability of ≥60% at ≥4% (w/w) sunflower protein concentrate after 1 hour.
20. The sunflower protein concentrate of any of Aspects 10-19 having a foaming stability of 60-90% at ≥4% (w/w) sunflower protein concentrate after 1 hour.
21. The sunflower protein concentrate of any of Aspects 10-20 having an emulsion stability of 100% at ≥1% (w/w) sunflower protein concentrate in oil/water (50/50) after ≥24 hours.
22. The sunflower protein concentrate of any of Aspects 10-21 having an emulsion stability of 100% at 1-5% (w/w) sunflower protein concentrate in oil/water (equal parts by volume) after ≥24 hours.
23. The sunflower protein concentrate of any of Aspects 21-22, wherein the emulsion is prepared at pH 5-7.
24. The sunflower protein concentrate of any of Aspects 10-23 having a least gelation concentration of about 5% in water.
25. The sunflower protein concentrate of any of Aspects 10-24 having a solubility of 18-30% at pH 7 at a concentration of 1-5% by weight in water.
26. The sunflower protein concentrate of any of Aspects 10-25 having a water holding capacity of 4-10 g/g and a oil holding capacity of 3-9 g/g.
27. A foam comprising the sunflower protein concentrate of any of Aspects 10-26
28. A gel comprising the sunflower protein concentrate of any of Aspects 10-26.
29. An emulsion comprising the sunflower protein concentrate of any of Aspects 10-26.
30. Use of the sunflower protein concentrate of any of Aspects 10-26 in a food or beverage application.
31. The use of Aspect 30, wherein the food or beverage application is selected from milk shake, protein bars, meat analogues, confectionary, condiments, mayonnaise, salad dressing, nutritional supplements and diary alternatives.
32. The use of Aspect 31, wherein the dairy alternative is selected from creamers, ice cream, yogurt, buttermilk and cheese.
33. A food or beverage comprising the sunflower protein concentrate of any of Aspects 10-26.

### EXAMPLES

The following examples are put forth so as to provide those of ordinary skill in the art with a complete disclosure and description of how to make and use the present invention, and are not intended to limit the scope of what the inventors regard as their invention nor are they intended to represent that the experiments below are all or the only experiments performed. Efforts have been made to ensure accuracy with respect to numbers used (e.g., amounts, temperature, etc.) but some experimental errors and deviations should be accounted for. Unless indicated otherwise, parts are parts by weight, temperature is in degrees Centigrade, and times are in minutes.

All publications and patent applications cited in this specification are herein incorporated by reference as if each individual publication or patent application were specifically and individually indicated to be incorporated by reference.

The present invention has been described in terms of particular embodiments found or proposed by the present inventor to comprise preferred modes for the practice of the invention. It will be appreciated by those of skill in the art that, in light of the present disclosure, numerous modifications and changes can be made in the particular embodiments exemplified without departing from the intended scope of the invention. All such modifications are intended to be included within the scope of the appended claims.

### Example 1: Extraction of Sunflower Seed Oil from Sunflower Seed Flour

### A.

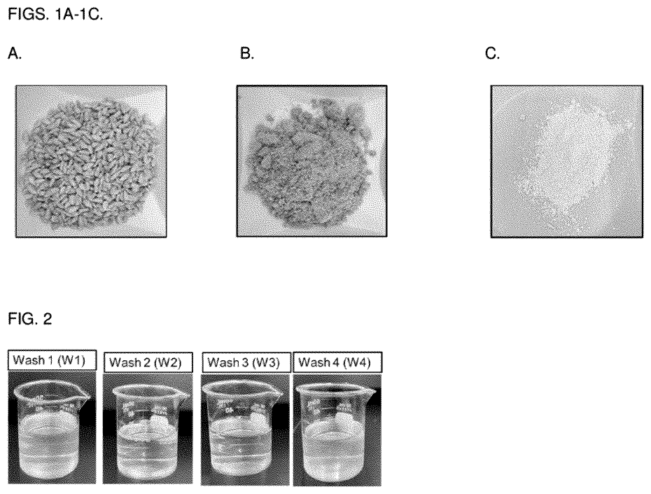

Sunflower seeds were ground in a mill at room temperature to form a sunflower seed flour. The sunflower seed flower was extracted with hexane at a flour to hexane ratio of about 1:2 (w:v) in a Nutsche Filter at an extraction temperature of about 50° C. and an extraction time of 15 minutes. FIGS. 1A, B and C show sunflower seeds, ground sunflower seed flour and de-oiled sunflower seed flour, respectively. The extraction cycle was repeated 4 times. FIG. 2 shows the hexane with extracted oil after each of 4 rounds of extraction. Table 1 shows the dry matter (DM) content and Brix refractive index of the hexane and oil after four sequential extraction cycles, showing that ≥97% oil extraction was complete after 2-4 cycles.

TABLE 1

| | Hx | DM | Brix |
|---|---|---|---|
| Wash | (mL) | (%) | RI |
| W0 | 0 | — | 26.1 |
| W1 | 400 | 25.5 | 37.6 |
| W2 | 400 | 8.8 | 29.9 |
| W3 | 400 | 0.6 | 27.1 |
| W4 | 400 | 0.2 | 26.2 |

Sunflower seed flour was desolventized at 55° C. for 30 minutes. The de-oiled sunflower seed flour obtained had ≤3% oil, about 50% protein (dry basis) and 60-100 ppm hexane.

### B.

Sunflower seeds were dehulled and further mild milled at room temperature to form a sunflower seed flour. The mild milled sunflower seed flour was extracted with hexane at a flour to hexane ratio of about 1:3 (w:v) in a Nutsche Filter at an extraction temperature of about 50° C. and an extraction time of 15 minutes. The extraction cycle was repeated 4 times. ≥97% oil extraction was complete after 2-4 cycles.

### C.

Sunflower seeds were dehulled and flaked at room temperature to form a sunflower seed flour. The flaked sunflower seed flour was extracted with hexane at a flour to hexane ratio of about 1:3 (w:v) in a Nutsche Filter at an extraction temperature of about 50° C. and an extraction time of 15 minutes. The extraction cycle was repeated 4 times. ≥97% oil extraction was complete after 2-4 cycles.

### Example 2: Extraction of Sunflower Protein Concentrate

### A.

De-oiled, desolvented sunflower seed flour containing 45-55% protein content (N×6.25) on a dry basis was placed in a 30-70% ethanol in water solution at pH 4-5 and a temperature of 50-60° C. for 15-30 minutes. The alcohol was then removed from the sunflower protein concentrate and water in a desolventizer, maintaining a temperature at or below 60° C. The sunflower protein concentrate was then dried at a temperature below 60° C. to a moisture content of 4-10%. FIG. 3 shows dried sunflower protein concentrate.

### B.

De-oiled, desolvented sunflower seed flour containing 45-55% protein content (N×6.25) on a dry basis was placed in a 40% ethanol in water solution at pH 6-7 and a temperature of 50-60° C. for 30 minutes. The alcohol was then removed from the sunflower protein concentrate and water in a desolventizer, maintaining a temperature at or below 60° C. The sunflower protein concentrate was then dried at a temperature below 60° C. to a moisture content of 4-10%.

### Example 3: Maintained Integrity of Native Protein Form in Sunflower Protein Concentrate

Differential scanning calorimetry was performed on the resulting SFPC (FIG. 4), showing a thermal transition profile with an exothermal event occurring at about 101° C., corresponding to the denaturation of protein in the SFPC. This confirms that the protein in the SFPC is substantially in its native form.

### Example 4: Protein Composition of SFPC

SFPC produced using the extraction process taught herein was analyzed by SDS-PAGE, which separated proteins in a sample by their molecular weight. FIG. 5 shows an SDS-PAGE analysis of SFPC, showing the presence of 11S helianthin proteins and 2S albumin proteins. For the protein fraction of the SFPC sample, 11S helianthin proteins made up 55-75% and 2S albumin proteins made up 15-30%.

### Example 5: Gelling Capacity of SFPC

Least gelation concentration (LGC) was determined for one batch of SFPC produced as described herein. LGC was determined using various concentrations of SFPC in water. The mixture was heated to 95° C., then cooled to 5° C. The LGC for this batch was determined to be about 5%. Sample gels produced at 5% and 10% SFPC are shown in FIG. 6.

### Example 6: Foaming Capacity of SFPC

Foams were made with 20 ml of a 5% SFPC solution in water. Foams were made using a homogenizer at 10000 rpm for 5 minutes. Foaming expansion capacity (% FE) was calculated using the equation % FE=Vfo/Vli×100, where Vfo is foam volume and Vli is the volume of the liquid before foaming. The SFPC displayed a foaming expansion capacity of 180-300%. FIG. 7A shows an example of foam generates as described.

Foaming stability (% FS) was determined using the equation % FS=[(Vli−Vlt)/(Vli−Vlo)], where Vlt is the liquid volume after 200 minutes, and Vlo is the volume of liquid immediately after foaming. The SFPC displayed a foaming stability of 50-95% after 1 hour. FIG. 7B shows the Foam from FIG. 7A one hour later.

### Example 7: Emulsion Capacity of SFPC

Emulsions using varied concentrations of SFPC (1-5% weight to weight) in a mixture of equal parts oil and water (by volume) were made using a homogenizer at 8000 rpm for 3 minutes. The emulsions displayed 100% stability after 24 hours. FIG. 8A shows examples of emulsions made with SFPC at pH 7. FIG. 8B show the mayonnaise-like quality of the SFPC emulsion.

1. A sunflower seed protein concentrate process comprising:
a. extracting in 30-70% ethanol in water (by volume) from de-oiled, desolvented sunflower seed flour having ≤3% oil, the extraction comprising the parameters of:
i) maintaining a temperature of 30-62° C.,
ii) at a pH range of pH 4-7.
b. removing the ethanol from the sunflower protein concentrate and water;
c. optionally washing the sunflower protein concentrate with water at pH 4-6, then diluting the sunflower protein concentrate with water at pH 7 to create a slurry and homogenizing said slurry,
d. optionally sterilizing and/or pasteurizing the wet sunflower protein concentrate, and
e. drying the wet sunflower protein concentrate to a moisture range of 4-10%.

2. The process of claim 1, wherein the extraction is performed in a Nutsche filter.

3. The process of claim 1, wherein the de-oiled, desolvented sunflower seed flour contains ≤2% oil.

4. The process of claim 1, wherein the sunflower seed flour contains ≤500 ppm hexane.

5. The process of claim 1, wherein the de-oiled, desolvented sunflower seed oil contains ≤100 ppm hexane.

6. The process of claim 1, wherein steps a. is carried out at 50-60° C.

7. The process of claim 1, wherein step a. is carried out at pH 4-5.

8. The process of claim 1, wherein step a. is carried out for 15-30 minutes.

9. The process of claim 1, wherein steps b., c. and e. are carried out at about ≤60° C.

10. A sunflower protein concentrate produced by the process of claim 1.

11. The sunflower protein concentrate of claim 10 having a protein content of 50-75% protein.

12. The sunflower protein concentrate of claim 10 having a protein content of 55-70% protein.

13. The sunflower protein concentrate of claim 10 comprising in its protein component 50-90% 11 S helianthin and 10-40% 2S albumin and oleosin proteins.

14. The sunflower protein concentrate of claim 10 comprising in its protein component 55-75% 11S helianthin and 15-30% 2S albumin and oleosin proteins

15. The sunflower protein concentrate of claim 10 comprising:
a. 1-3% oil,
b. 30-40% carbohydrates,
c. 4-6% ash,
d. 0.1-2% chlorogenic acid.

16. The sunflower protein concentrate of claim 10, wherein the protein is substantially in its native form.

17. The sunflower protein concentrate of claim 10 having a foaming expansion capacity of ≥180% at ≥4% (w/w) sunflower protein concentrate in water.

18. The sunflower protein concentrate of claim 10 having a foaming expansion capacity of 180-300% at ≥4% (w/w) sunflower protein concentrate.

19. The sunflower protein concentrate of claim 10 having a foaming stability of ≥60% at ≥4% (w/w) sunflower protein concentrate after 1 hour.

20. The sunflower protein concentrate of claim 10 having a foaming stability of 60-90% at ≥4% (w/w) sunflower protein concentrate after 1 hour.

21. The sunflower protein concentrate of claim 10 having an emulsion stability of 100% at ≥1% (w/w) sunflower protein concentrate in oil/water (50/50) after ≥24 hours.

22. The sunflower protein concentrate of claim 10 having an emulsion stability of 100% at 1-5% (w/w) sunflower protein concentrate in oil/water (equal parts by volume) after ≥24 hours.

23. The sunflower protein concentrate of any of claims 21-22, wherein the emulsion is prepared at pH 5-7.

24. The sunflower protein concentrate of claim 10 having a least gelation concentration of about 5% in water.

25. The sunflower protein concentrate of claim 10 having a solubility of 18-30% at pH 7 at a concentration of 1-5% by weight in water.

26. The sunflower protein concentrate of claim 10 having a water holding capacity of 4-10 g/g and a oil holding capacity of 3-9 g/g.

27.-33. (canceled)

34. The process of claim 1, wherein the protein content of the dried de-oiled sunflower seed flour is 45-55% protein (N×6.25), on a dry basis.
